(19) United States
(12) Patent Application Publication
(10) Pub. No.: US 2023/0349029 A1
(43) Pub. Date: Nov. 2, 2023

(54) WEAR RESISTANT BORIDE FORMING FERROUR ALLOYS FOR POWDER BED FUSION ADDITIVE MANUFACTURING

(71) Applicant: MACLEAN-FOGG COMPANY, Mundelein, IL (US)

(72) Inventors: Jonathan TRENKLE, Mundelein, IL (US); Harald LEMKE, Mundelein, IL (US)

(73) Assignee: MACLEAN-FOGG COMPANY, Mundelein, IL (US)

(21) Appl. No.: 18/012,544

(22) PCT Filed: Jun. 22, 2021
(86) PCT No.: PCT/US2021/038464

§ 371 Date: Dec. 22, 2022

Related U.S. Application Data
(60) Provisional application No. 63/042,202, filed on Jun. 22, 2020.

(51) Int. Cl. C22C 38/54; C22C 38/46; C22C 38/44; C22C 38/42; C22C 38/04; C22C 38/02; B33Y 80/00; B33Y 70/00; B33Y 40/20; B33Y 10/00; B22F 10/28; B22F 10/64

(52) U.S. Cl. CPC C22C 38/54; C22C 38/46; C22C 38/44; C22C 38/42; C22C 38/04; C22C 38/02; B33Y 80/00; B33Y 70/00; B33Y 40/20; B33Y 10/00; B22F 10/28; B22F 10/64; B22F 2998/10; B22F 2999/00; B22F 2301/35

(57) ABSTRACT

The present application relates to ferrous (steel) alloy compositions that can be printed by powder bed fusion additive manufacturing. The combination of printability and properties is achieved by formulating chemistries specifically for the powder bed fusion process.

### CROSS-REFERENCE TO RELATED APPLICATIONS

This application claims the benefit of U.S. provisional application Ser. No. 63/042,202 filed Jun. 22, 2021 the disclosure of which is hereby incorporated in its entirety by reference herein.

### TECHNICAL FIELD

The present application relates to ferrous (steel) alloy compositions that can be printed by powder bed fusion additive manufacturing.

### BACKGROUND

In the most general form, additive manufacturing, also known as 3D printing, involves layer-by-layer deposition of materials to “build” or “print” an object in three dimensions. There are several advantages in manufacturing this way, including producing complex geometries, reducing production times, innovating rapidly, eliminating inventory, and saving material costs.

In tooling, specifically, conformal cooling channels are an example of a complex geometry that would otherwise not be possible or would be cost restrictive by subtractive manufacturing. Conformal cooling channels are internal pathways that follow closely to the shape and direction of exterior-facing surfaces to enable maximum thermal management by fluid pumped through the channels. Conformal cooling channels can extend tool lifetime and reduce part production cycle times (i.e. the time required to produce a part by the tool), both of which can lower costs.

### SUMMARY

In at least one embodiment, a method of layer-by-layer construction of a metallic part is provided. particles of an iron-based alloy are supplied. The iron-based alloy has Cr in an amount ranging from 9.0 wt. % to 16.0 wt. %; Ni in an amount of 5.0 wt. or less %; Mo in an amount of 3.0 wt. or less %; Mn in an amount of 3.0 wt. or less %; C in an amount ranging from 0.1 wt. % to 0.30 wt. %; B in an amount of 1.0 wt. or less %. One or more elements selected from Cu, W, or V are present. When Cu is present it is present in an amount up to 2.5 wt. %; when W is present it is present in an amount up to 7.5 wt. %; when V is present it is present in an amount up to 3.5 wt. %. The balance of the iron-based alloy contains Fe. An as-built metallic part is formed at least in part by powder bed fusion including melting the particles into a molten state and cooling and forming one or more solidified layers of the iron-based alloy containing a martensitic matrix and one or more of a Cr-boride, W-boride when W is present or V-boride when V is present. In the as-built part has a HRC hardness H1 and an abrasion wear resistance W1 (mass loss in grams via ASTM G65-16e1 Procedure A). The as-built part is heat treated, wherein the heat-treated part indicates a second value for HRC hardness (H2) and abrasion wear resistance (W2) where W2<W1.

In another embodiment, the as-built part has a tensile strength of at least 1000 MPa, a yield strength of at least 700 MPa, an elongation of at least 0.25%, and a hardness (HRC) of at least 40.

In another embodiment, after heat treatment, the metallic part has an elongation of at least 5.0%, a HRC hardness of at least 50 and abrasion wear resistance (mass loss in grams via ASTM G65-16e1 Procedure A) of less than or equal to 1.90.

In another embodiment, the heat treatment comprises heating at a temperature of 900° C. to 1200° C. for 0.5 to 8.0 hours.

In another embodiment, Cu when present is present at a level of 0.15 wt. % to 0.30 wt. %, when W is present it is present at a level of 0.1 wt. % to 5.5 wt. % and when V is present it is present at a level of 0.1 wt. % to 2.25 wt. %.

In another embodiment, the alloy after heat treating contains a Cr-rich boride phase

In another embodiment, the alloy contains Win an amount of 0.1 wt. % to 5.5 wt. % and the alloy after heat treating contains a W-rich boride phase.

In another embodiment, the alloy contains V in an amount of 0.1 wt. % to 2.25 wt. % and the alloy after heat treating contains a V-rich boride phase.

In another embodiment, the alloy has Cr in an amount ranging from 9.0 wt. % to 19.0 wt. %; Ni in an amount up to 3.0 wt. %; Mo in an amount ranging from 0.2 wt. % to 0.8 wt. %; Mn in an amount ranging from 0.75 wt. % to 3.0 wt. %; C in an amount ranging from 0.1 wt. % to 0.25 wt. %; B in an amount ranging from 0.25 wt. % to 0.75 wt. %.

In another embodiment, the alloy, when Cu is present it is present in an amount up to 0.8 wt. %; when W is present it is present in an amount up to 5.5 wt. %; when V is present it is present in an amount up to 2.5 wt. %.

In at least one embodiment, a method of layer-by-layer construction of a metallic part comprising supplying particles of an iron-based alloy, the iron-based alloy comprising Cr in an amount ranging from 9.0 wt. % to 16.0 wt. %, Ni in an amount ranging from 2.0 wt. % to 3.0 wt. %, Mo in an amount ranging from 0.2 wt. % to 0.8 wt. %, Mn in an amount ranging from 0.75 wt. % to 3.0 wt. %, C in an amount ranging from 0.1 wt. % to 0.25 wt. %, B in an amount ranging from 0.25 wt. % to 0.25 wt. %, one or more elements selected from Cu, W, or V wherein when Cu is present it is present in an amount up to 0.3 wt. %, when W is present it is present in an amount up to 5.5 wt. %, when V is present it is present in an amount up to 2.25 wt. %. The balance of the iron-based alloy contains Fe. One forms an as-built metallic part at least in part by powder bed fusion comprising melting the particles into a molten state and cooling and forming one or more solidified layers of the iron-based alloy containing a martensitic matrix and one or more of a Cr-boride, W-boride when W is present or V-boride when V is present. In the as-built condition the part has a HRC hardness H1 and an abrasion wear resistance W1 (mass loss in grams via ASTM G65-16e1 Procedure A) and heat treating the part wherein the part indicates a second value for HRC hardness (H2) and abrasion wear resistance (W2) that are as follows: H2=H1+/−10 and W2<W1.

### BRIEF DESCRIPTION OF THE DRAWINGS

FIG. 1 illustrates a Scheil solidification curve calculated for Alloy A1.

FIG. 2 illustrates a Scheil solidification curve calculated for Alloy A3.

FIG. 3 illustrates a Scheil solidification curve calculated for Alloy A4.

FIG. 4 illustrates the calculated martensite start temperature and carbon content of austenite formed during solidification of Alloy A1.

FIG. 5 Error! Reference source not found. illustrates the calculated martensite start temperature and carbon content of austenite formed during solidification of Alloy A3.

FIG. 6 illustrates the calculated martensite start temperature and carbon content of austenite formed during solidification of Alloy A4.

FIG. 7 illustrates the X-ray diffraction results of PBF printed bar of Alloy A1.

FIG. 8 illustrates a microstructure of as-built Alloy A1.

FIG. 9 illustrates a microstructure of as-built Alloy A3.

FIG. 10 illustrates a microstructure of as-built Alloy A4.

FIG. 11 illustrates a micrograph of as-built Alloy A1.

FIG. 12 illustrates a micrograph of as-built Alloy A2.

FIG. 13 illustrates a micrograph of as-built Alloy A3.

FIG. 14 illustrates a micrograph of as-built Alloy A4.

FIG. 15 illustrates a calculated equilibrium phase diagram of Alloy A1.

FIG. 16 illustrates a calculated equilibrium phase diagram of Alloy A3.

FIG. 17 illustrates a calculated equilibrium phase diagram of Alloy A4.

FIG. 18 illustrates a microstructure of PBF printed bar of Alloy A1 after heat treatment with aging step at 1100° C. for 2 hours.

FIG. 19 illustrates a microstructure of PBF printed bar of Alloy A1 after heat treatment with aging step at 1100° C. for 4 hours.

FIG. 20 illustrates a microstructure of PBF printed bar of Alloy A1 after heat treatment with aging step at 1100° C. for 8 hours

FIG. 21 illustrates a microstructure of PBF printed bar of Alloy A3 after heat treatment with aging step at 1100° C. for 2 hours.

FIG. 22 illustrates a microstructure of PBF printed bar of Alloy A3 after heat treatment with aging step at 1100° C. for 8 hours.

FIG. 23 illustrates a microstructure of PBF printed bar of Alloy A4 after heat treatment with aging step at 1100° C. for 8 hours.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

There are several metal additive manufacturing methods. Additive manufacturing may be used for making tooling used in industrial manufacturing processes, such as metal die casting, injection molding, hot stamping, and compression forming. One additive manufacturing method for making tooling is laser powder bed fusion (L-PBF or simply “PBF”). PBF can produce nearly 100% dense pieces with properties similar or better than those of their wrought counterparts while achieving dimensional tolerances, near-net shape and surface roughness that require no to minimal post-printing finishing. Furthermore, the size of the pieces printed by PBF are limited only by the size of the equipment. Other common metal additive manufacturing methods such as binderjet or direct energy deposition (DED) have limitations in one or more of these aspects. For example, the maximum density binderjet typically achieves is less than 99% and the size is limited by the need to remove binder entrapped in the part during printing. In DED, the tolerances and surface finish require post-printing finishing. Beyond tooling, other specialty parts that require high performance and reliability, such as those used in aerospace and biomedical applications, also prefer PBF for these same reasons.

One aspect where PBF is disadvantaged over other methods with respect to tooling is the availability of printable tool steels. Conventional wrought tool steels that provide the requisite properties, including hardness and wear resistance, cannot be printed efficiently or economically by PBF without cracking. H13, one of the most commonly used tool steels, requires printing relatively slowly (typically 9 cm³/hr or less) or preheating the powder bed to 300° C. or higher to avoid cracking. Implementing either of these options increases printing time, and thus cost, while the latter also jeopardizes quality and consistency. Even then, these strategies are not guaranteed to prevent cracking when large pieces are printed.

Steels that are printable by PBF such as 316L, M300, and 17-4 PH, either do not have the hardness, wear resistance or both for many tooling applications. M300 for example can have relatively high hardness but the abrasion wear resistance is nominally half that of H13. Additionally, steels like M300 and 17-4 PH are relatively soft after printing, requiring a post-printing aging heat treatment to increase hardness, which adds manufacturing time and costs.

The disclosure presented here addresses the need for an alloy composition that can be used to print tools and specialty parts by PBF with a combination of relatively high hardness, strength, elongation, and wear resistance.

The present disclosure describes ferrous alloy compositions that are printable by powder bed fusion (PBF) methods and have a combination of relatively high hardness and wear resistance in the “as-built” and “heat-treated” states. Printability in this context refers to the ability to additively manufacture or 3D print a part preferably without defects such as cracking or porosity. The “as-built” state is defined as that produced by the PBF printer that achieves the indicated mechanical properties in such as-built condition. The as-built state is contemplated to include heating to relieve stress that may otherwise be present in the as-built part. The combination of printability and properties is achieved by formulating chemistries specifically for the powder bed fusion process.

As noted above, the alloy comprises Cr at 9.0 wt. % to 16.0 wt. %, Ni at 2.0 wt. % to 3.0 wt. %, Mo at 0.2 wt. % to 0.8 wt. %, Mn at 0.75 wt. % to 3.0 wt. %, C at 0.1 wt. % to 0.25 wt. % and B at 0.25 wt. % to 0.75 wt. %. The alloy may include one or more elements selected from Cu, W or V wherein when Cu is present in the alloy, it is present in an amount of up to 0.3 wt. % or less, when W is present in the alloy, it is present in an amount of up to 5.5 wt. % and when V is present in the alloy, it is present in an amount of up to 2.25 wt. %. The layer-by-layer construction of such alloy therefore provides for the formation of a martensitic matrix containing one or more of a Cr-boride, W-boride when W is present, or V-boride when V is present. It is noted that reference to the presence of a martensitic matrix for the recited borides does not exclude the presence of some retained austenite/ferrite that may also be present in the printed alloy part.

The alloy composition may therefore comprise Cr at 9.0 wt. % to 16.0 wt. %, Ni at 2.0 wt. % to 3.0 wt. %, Cu at 0.15 wt. % to 0.30 wt. %, Mo at 0.2 wt. % to 0.8 wt. %, Mn at 0.75 wt. % to 3.0 wt. %, C at 0.1 wt. % to 0.25 wt. % and B at 0.25 wt. % to 0.75 wt. %. The balance is then Fe. Such alloy as noted above contains Cr-boride in a martensitic matrix. In addition, upon heat treatment of the as-built alloy part, a Cr-rich boride can be formed, which is reference to the feature that the dominant species of metallic element in the borides present is Cr. By way of example, for the boride M2B_CB discussed further herein, the dominant metallic element in such boride would be Cr.

The alloy composition may therefore comprise Cr at 9 wt. % to 16 wt. %, Ni at 2.0 wt. % to 3.0 wt. %, Mo at 0.2 wt. % to 0.8 wt. %, Mn at 0.75 wt. % to 3.0 wt. %, C at 0.1 wt. % to 0.25 wt. %, B at 0.25 wt. % to 0.75 wt. % and W at 0.1 wt. % to 5.5 wt. %. The balance is then Fe. Such alloy as noted above contains W-boride in a martensitic matrix. In addition, upon heat treatment of the as-built alloy part, a W-rich boride can now be formed, which is reference to the feature that the dominant species of metallic element in the borides present is W. By way of example, for the boride M2B_C16 discussed further herein, the dominant metallic element in such boride would be W.

The alloy composition may therefore comprise Cr at 9 wt. % to 16 wt. %, Ni at 2.0 wt. % to 3.0 wt. %, Mo at 0.2 wt. % to 0.8 wt. %, Mn at 0.75 wt. % to 3.0 wt. %, C at 0.1 wt. % to 0.25 wt. %, B at 0.25 wt. % to 0.75 wt. % and Vat 0.1 wt. % to 2.25 wt. %. The balance is then Fe. Such alloy as noted above contains V-boride in a martensitic matrix In addition, upon heat treatment of the as-built alloy part, a V-rich boride can now be formed, which is reference to the feature that the dominant species of metallic element in the borides present is V. By way of example, for the boride MB_B33 discussed further herein, the dominant metallic element in such boride would be V.

With regards to the alloy compositions herein, it should be noted that they may contain incidental impurities. Such incidental impurities may include the impurities present in a given commercially available reagent element selected for preparation of the alloy compositions. The incidental impurities may also result from the powder production process, such as nitrogen from gas atomization. The level of such incidental impurities may therefore range up to but not including 0.1 wt. %, any may e.g., include nitrogen or some other residual element, again being present at a level of up to but not including 0.1 wt. %.

A layer herein is formed by melting of the alloys in powder form, wherein the alloy powder contains particles that are of a size of 1.0 micron to 150 microns in diameter. In another embodiment, the powder contains particles that are of a size of 10 micron to 100 micron in diameter. In another embodiment, the powder contains particles that are of a size of 15 micron to 80 micron in diameter. Such powder form may be provided by gas atomization or water atomization of the aforementioned alloy compositions. The powder is then spread onto a building surface in a layer that is 10 microns to 200 microns thick. In another embodiment, the powder is then spread onto a building surface in a layer that is 20 microns to 100 microns thick. In another embodiment, the powder is then spread onto a building surface in a layer that is 30 microns to 80 microns thick. One employs a high energy light source, such as a laser or electron beam followed by solidification of the melted powder.

Forming one or more layers in this way in any direction or orientation results in a volume of material that has the following as-built properties: a hardness of 35 HRC to 56 HRC as measured by ASTM E18-20, abrasion wear loss of 2.2 g or less as measured by ASTM G65-16e1 Procedure A, yield strength of at least 700 MPa, tensile strength of at least 1000 MPa, and elongation of at least 0.25% as measured by ASTM E8M-16ae1. In addition, the as-built alloys have a porosity of less than or equal to 1.0% as measured by optical microscopy per ASTM E1245-03.

The alloys in the as-built condition are then heat treated in a manner that is designed to influence or improve one or more properties, such as the abrasion wear resistance of the part. The heat treatment is also one that is designed to increase the diameter of the borides that are present in the as-built condition. Accordingly, for a given part having an initial set of properties in the as-built condition, namely yield strength YS1, tensile strength TS1, elongation E1, HRC hardness H1 and abrasion wear resistance W1 (mass loss in grams via ASTM G65-16e1 Procedure A), after heat treatment, the part properties indicate a second value for yield strength (YS2), tensile strength (TS2) elongation (E2), HRC hardness (H2) and abrasion wear resistance (W2) that are as follows: YS2>YS1, TS2>TS1, E2≥E1, H2=H1+/−10 and W2<W1. Further, E2 is at least 5.0% greater than E1 and W2 is at least 0.5 lower in value than W1.

Heat treating to influence or improve properties and altering the size of the borides in the martensitic matrix amounts to heating at 900° C. to 1200° C. for at least 0.5 hour followed by cooling, such as quenching. Further, heating at 900° C. to 1200° C. for 0.5 to 9.0 hours followed by such cooling. After such heat treatment, one may also then temper at a temperature of 600° C. or less, or in the range of 100° C. to 600° C. for a time period in the range of 10.0 minutes to 4.0 hours. Heat treating processes described in co-pending applications U.S. application Ser. No. 17/248,953 are hereby incorporated by reference.

During PBF, a layer of powder having the alloy compositions herein is spread onto a platform or bed, referred to as the substrate. A laser with a relatively small spot size then melts the powder in selective locations corresponding to the shape of the part being printed. The molten metal cools relatively rapidly, contemplated to be in the range of 10⁴° C./s to 10⁶° C./s forming a solid continuous layer on top of the substrate or previously printed layers. This process is repeated until the final part is formed. When the layer of powder is melted, the underlying printed metal will experience another cycle of heating and cooling with the temperature and cooling rate decreasing with distance from the powder layer. The localized nature of the melting, constrained substrate, and cyclical heating and cooling can generate significant stresses.

During the relatively rapid cooling from a melt, the microstructure of the alloys herein can transition from predominantly liquid to austenite to martensite, which is a relatively hard and relatively brittle phase. The hardness of a martensitic microstructure is desirable for selected applications and as noted above, the alloys herein now include one or more of Cr-borides, W-borides or V-borides. It is worth noting that without being bound to any theory, it is believed that the presence of such borides provides for the improved wear resistance disclosed herein (both as-built and after heat treatment). In such context, it is worth noting that conventional wrought tool steels which are used in high wear applications for example, typically rely on carbon content not only to form hard martensite but also to form carbides to enhance wear resistance. However, the transformation of austenite to martensite is associated with a volume change, the magnitude of which increases with carbon content. If the volume of steel undergoing this transition is constrained, as is the case with PBF, stresses can evolve that are a function of the carbon content. In combination with the thermal stresses mentioned previously and in the presence of brittle martensite, with relatively high levels of carbides, cracking can occur.

Cracking can also potentially occur during solidification from the melt, a phenomenon known as solidification cracking. The relatively rapid solidification of PBF provides little to no opportunity for equilibrium conditions to be reached during solidification. Significant segregation of alloying elements occurs in the liquid ahead of the solidification front, continuously depressing the solidus temperature of the liquid. Therefore, a liquid or semi-solid zone may be present in the solidifying metal as the stresses described previously increase. When the liquid or semi-solid cannot support these stresses, cavitation occurs resulting in a crack. These alloying elements cannot be removed however since they are needed to promote martensite and carbide formation in the tool steel.

To overcome these challenges, it can now be appreciated that the compositions herein have been designed that result in the formation of a microstructure consisting of a relatively hard martensitic matrix and boride-enriched secondary phase or precipitates that replace and reduce the level of carbides that are otherwise relied upon for enhancing wear resistance. As noted above, the compositions are such that upon heat treatment they contain Cr-rich borides, V-rich borides or W-rich borides, and the level of carbon is at 0.1 wt. % to 0.25 wt. %.

Parts are printed herein using commercially available PBF printers in an inert gas atmosphere but argon or nitrogen. The substrate is pre-heated between room temperature and 300° C., between room temperature and 250° C. The substrate is pre-heated between room temperature and 200° C. Steel substrates with similar thermal coefficient expansion as the printed alloy are preferred but it is contemplated that other steels and non-ferrous alloys can be used as substrates.

Printing parameters include laser power, laser velocity, hatch spacing, and layer thickness. The laser power is 100 W to 1000 W. In another embodiment, the laser power is between 150 W to 800 W. In another embodiment, the laser power is between 200 W to 500 W. The laser velocity is 100 mm/s to 2000 mm/s. In another embodiment, the laser velocity is 150 mm/s to 1750 mm/s. In another embodiment, the laser velocity is 200 mm/s to 1500 mm/s. The hatch spacing may be 10 microns to 250 microns. In another embodiment, the hatch spacing is 30 microns to 200 microns. In another embodiment, the hatch spacing 50 microns to 150 microns. The layer thickness is 10 microns to 200 microns thick. In another embodiment, the layer thickness is 20 microns to 100 microns thick. In another embodiment, the layer thickness is 30 microns to 80 microns thick. However, each parameter is not mutually exclusive from the others in printing a part with minimal defects, and furthermore, these values may change depending on the printer used and evolving printer technology. To account for this, energy density is often used as a metric and is defined by:

$$E = \frac{P}{h \times l \times v}$$

where P is the laser power, h is the hatch spacing, 1 is the layer thickness, and v is the laser velocity. Using this formula, the energy density for the alloys may be 10 J/mm³ to 500 J/mm³ In another embodiment, the energy density for the alloys may be 20 J/mm³ to 400 J/mm³. In another embodiment, the energy density for the alloys may be preferably 30 J/mm³ to 300 J/mm³.

The volume build speed, which is calculated by multiplying the laser velocity, hatch spacing, and layer thickness, is commercially important as it dictates the relative cost and availability of parts printed using these alloys. Here the speed may be 1 cm³/hr to 50 cm³/hr. In another embodiment, the speed may be 3 cm³/hr to 40 cm³/hr, or 5 cm³/hr to 30 cm³/hr.

Using these parameters and conditions, defects such as porosity and cracking that negatively affect the part performance are preferably minimized, which may be important for many applications including tooling. The average porosity in a part prepared from the alloys here by PBF may be less than 1.0%. In another embodiment, the average porosity is less than 0.5%. In another embodiment, the average porosity is less than 0.3%.

Table 1 lists four alloy compositions presented as examples of this present disclosure. These alloys were designed to form a boride phase in a martensitic matrix after printing and/or a heat treatment. As noted above, the boride phase includes one or more of Cr-borides, V-borides or W-borides.

In Alloys A1 and A2, the borides were more specifically intended to be Cr-rich while in Alloys A3 and A4, V-rich and W-rich borides, respectively, are preferentially formed over Cr-rich borides by the addition of V in an amount up to 2.25 wt. % or W in an amount up to 5.5 wt. %. The level of Cr that is present is also preferably such to aid in the formation of the relatively hard martensite phase in the matrix.

TABLE 1

| Element | A1 | A2 | A3 | A4 |
|---|---|---|---|---|
| Fe | Bal. | Bal. | Bal. | Bal. |
| Cr | 14.53 | 15.5 | 14.25 | 9.39 |
| Ni | 2.12 | 2.86 | 2.62 | 2.91 |
| Cu | 0.27 | 0.27 | | |
| Mo | 0.23 | 0.53 | 0.43 | 0.78 |
| Si | 0.7 | 0.84 | 0.5 | |
| Mn | 0.9 | 0.81 | 0.77 | 2.7 |
| W | | | | 5.05 |
| V | | | 2.17 | |
| C | 0.21 | 0.14 | 0.13 | 0.14 |
| B | 0.68 | 0.31 | 0.39 | 0.38 |

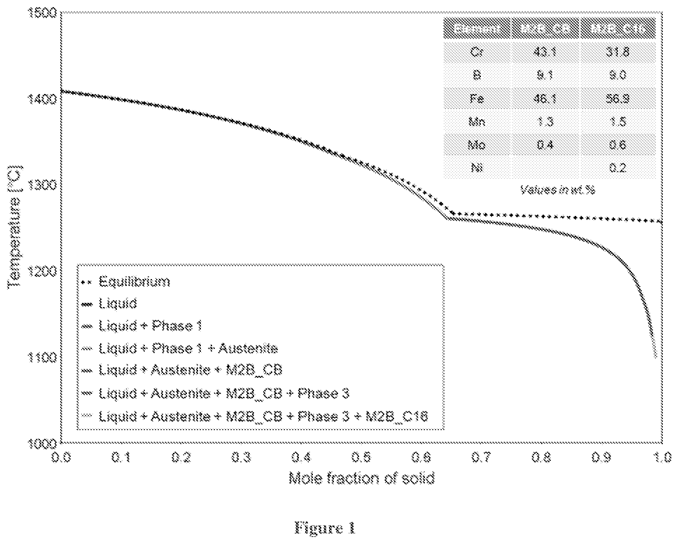

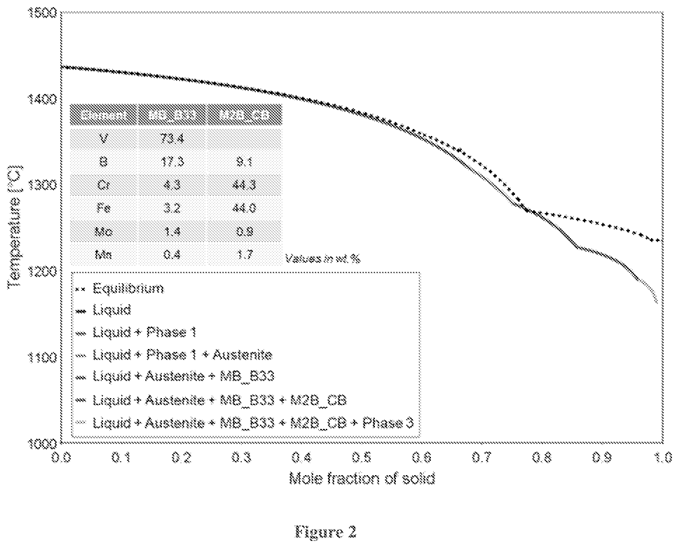

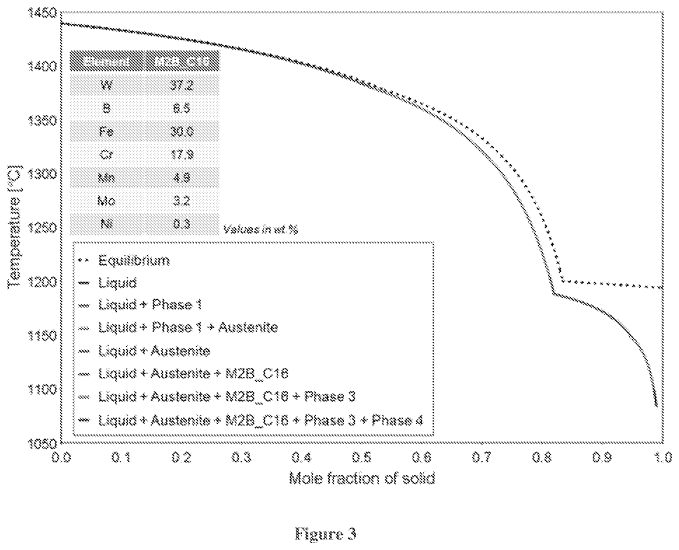

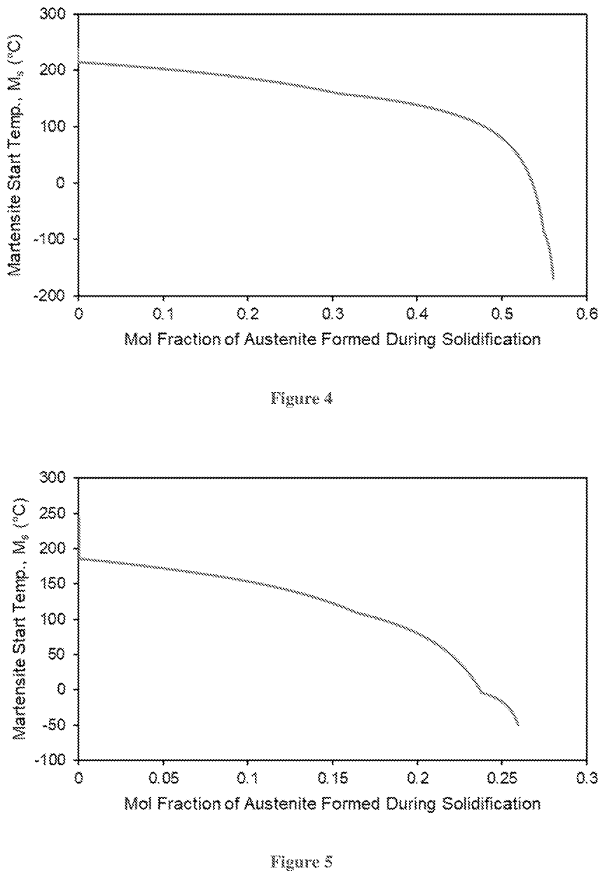

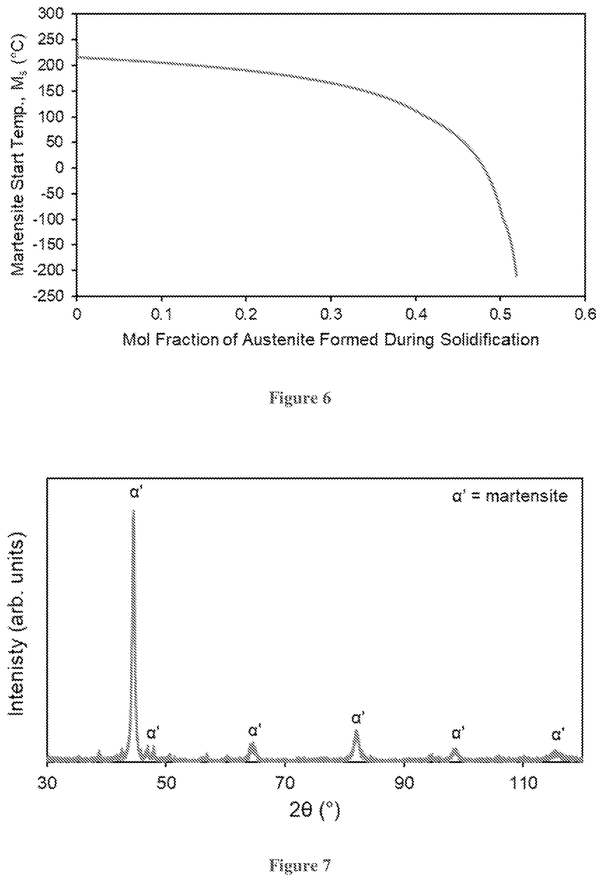

FIG. 1, FIG. 2 and FIG. 3 show Scheil solidification diagrams for Alloys A1, A3, and A4, respectively, calculated by Thermo-Calc software (Thermo-Calc Software, Inc., version 2019a, TCFE9: TCS Steels/Fe-alloys Database, v9). The Scheil solidification diagram is used because it best represents rapid solidification that is experienced by the powder when it is melted and cooled during PBF printing. These diagrams and calculations suggest that austenite forms early in solidification followed by borides. Relatively rapid cooling of austenite below the martensite start temperature Ms causes austenite to transform to martensite. The Ms is calculated from the composition of the austenite phase and shown for Alloys A1, A3, and A4 in FIG. 4, FIG. 5 and FIG. 6, respectively. Because the Ms for much of the austenite formed in these alloys is above room temperature, martensite is expected to form. The borides in Alloys A1, A3, and A4, are contemplated to be Cr-rich, V-rich, and W-rich, respectively. Although the chemistry of these borides evolves during solidification, a representative composition of each boride phase is provided in each figure. That is, the figures identify the boride crystal structures as M2B_CB or M2B_C16 or MB_B33 where M is reference to the particular metallic element present in weight percent. Reference to “phases” is a reference to other morphological solid states or crystal structures that may be present.

Bars of each alloy with dimensions 1 cm×1 cm×1 cm, 6.7 cm×1.4 cm×1.4 cm, and 7.4 cm×2.5 cm×0.6 cm were printed on a SLM28OHL laser PBF printer with a pre-heat temperature of 200° C. The laser power, velocity, hatch spacing, and layer thickness used for each alloy is presented in Table 2 and the powder size distribution used for each alloy is presented in Table 3.

TABLE 2

| Print Parameter | A1 | A2 | A3 | A4 |
|---|---|---|---|---|
| Laser Power (W) | 280 | 300 | 300 | 350 |
| Laser Velocity (mm/s) | 400 | 1000 | 1000 | 1200 |
| Hatch Spacing (um) | 100 | 120 | 100 | 100 |
| Layer Thickness (μm) | 40 | 40 | 40 | 40 |
| Energy Density (J/mm³) | 175 | 63 | 75 | 73 |
| Build Speed (cm³/hr) | 5.8 | 17.3 | 14.4 | 17.3 |

TABLE 3

| Alloy | D10 (μm) | D50 (μm) | D90 (μm) |
|---|---|---|---|
| A1 | 17.3 | 28.4 | 45.5 |
| A2 | 17.3 | 27.2 | 42.5 |
| A3 | 15.9 | 24.6 | 38.1 |
| A4 | 14.3 | 22.8 | 35.5 |

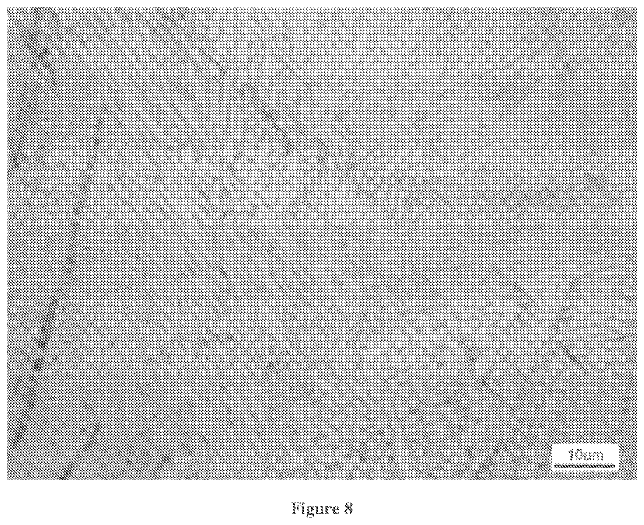

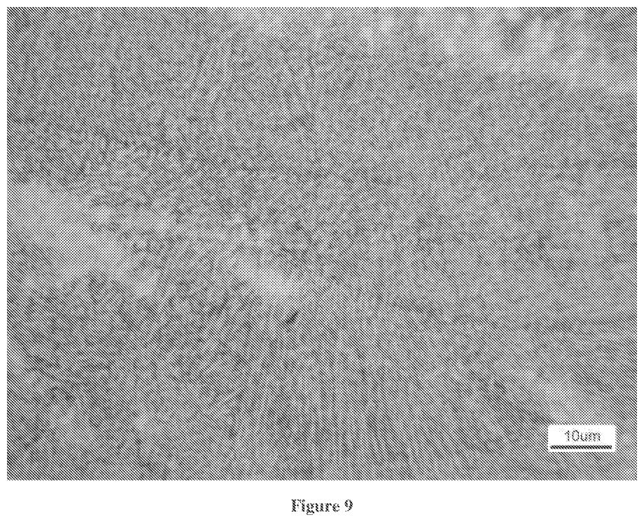

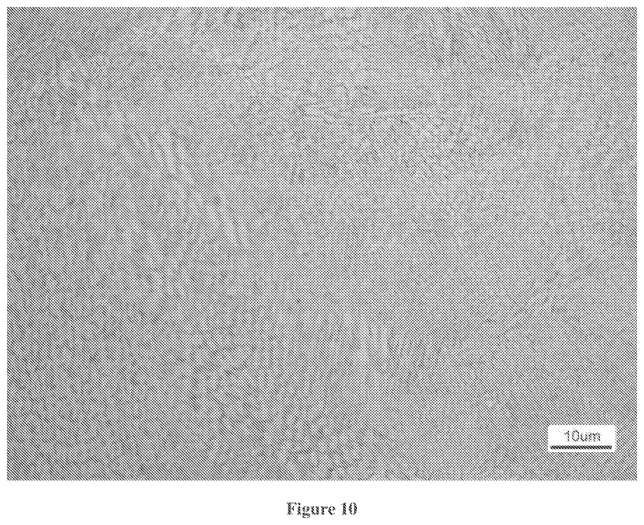

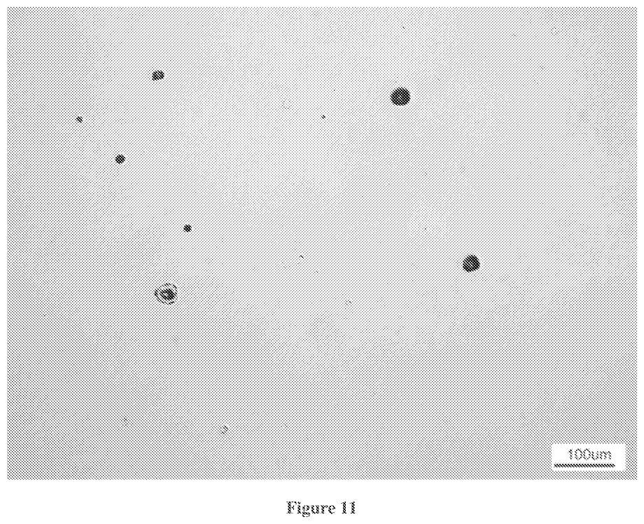

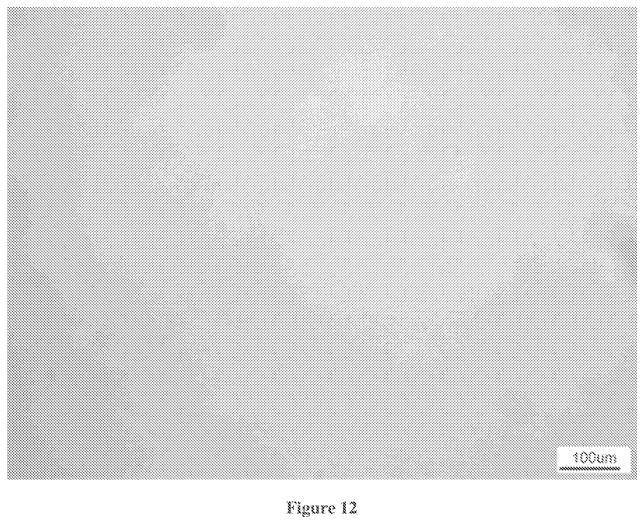

X-ray diffraction (XRD) results of a bar made of Alloy A1 in FIG. 7 indicate that the microstructure is primarily martensite as predicted by the alloys design and Thermo-Calc calculations. The microstructures of these bars shown in FIGS. 8, 9 and 10 for Alloys A1, A3, and A4, respectively, are dendritic, which is consistent with the segregation of alloying elements to the liquid during solidification and the formation of the borides towards the end of solidification. The darker phase decorating the dendrite perimeters is then presumably borides while the interior of the cells is the martensite.

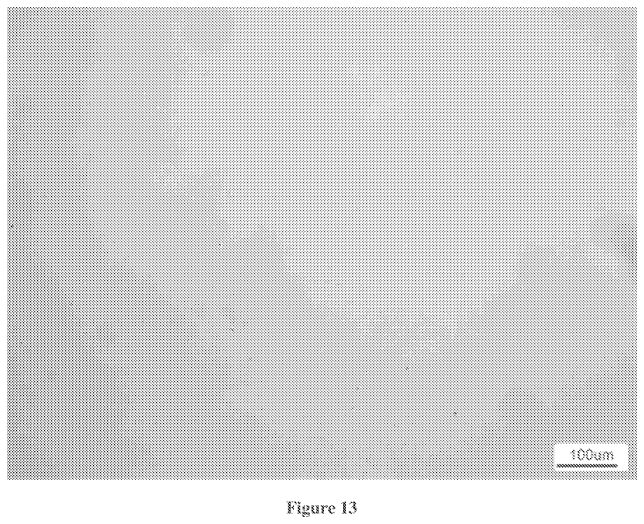

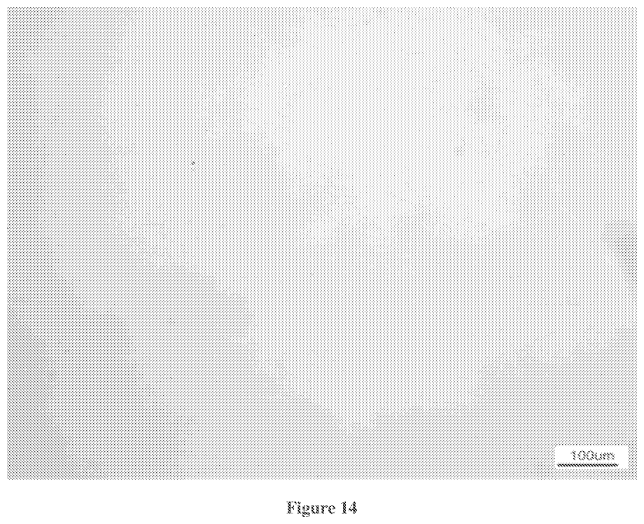

All printed bars are preferably free of cracks with relatively low average porosity ranging from 0.01% to 1.00%, as measured per ASTM E1245-03, which involves optical image analysis of a micrographic of a metallographic cross-section of the part. More preferably, the parts are such that there are no visible cracks present under a magnification of up to 1000× over the majority of the surface area of the part, such as 95% or more of the part surface area. Accordingly, this includes no visible cracks under a magnification of up to 1000× over 96% or more, 97% or more, 98% or more, 99% or more, or 100% of the part surface area. FIGS. 11, 12, 13 and 14 show micrographs of the 1 cm×1 cm×1 cm bars of Alloys A1, A2, A3, and A4, respectively as an example of the typical porosity observed in each alloy.

Table 4 lists the tensile properties, hardness, and abrasion wear mass loss of the as-built alloys listed in Table 1. The bars with dimensions 6.7 cm×1.4 cm×1.4 cm were tensile tested in accordance with ASTM E8-16ae1. The bars with dimensions 1 cm×1 cm×1 cm were hardness tested in accordance with ASTM E18-20. The bars with dimensions 7.4 cm×2.5 cm×0.6 cm were abrasion wear tested in accordance with ASTM G65-16e1 Procedure A. Abrasion wear resistance is inversely related to the mass loss (i.e. a higher mass loss indicates less wear resistance.) For comparison, tensile properties, hardness, and abrasion wear mass loss of conventional steels 316L, M300, 17-4 PH, and H13 printed on an SLM28OHL printer are also provided. Note that to print H13 without severe cracking, the powder bed needed to be pre-heated to 500° C.

TABLE 4

| | Yield | Tensile | | | Abrasion |
|---|---|---|---|---|---|
| | Strength | Strength | Elonga- | Hardness | Wear Mass |
| Alloy | (MPa) | (MPa) | tion (%) | (HRC) | Loss (g) |
| 316L | 432 | 634 | 58.1 | <30 | 3.28 |
| M300 | 1085 | 1176 | 19.1 | 37 | 2.89 |
| 17-4 PH | 865 | 967 | 22.8 | 32 | |
| H13 | 927 | 1082 | 1.1 | 56 | 1.76 |
| A1 | | | | 56 | 1.80 |
| A2 | 744 | 1187 | 0.3 | 53 | 2.10 |
| A3 | | | | 40 | 1.89 |
| A4 | 755 | 1280 | 0.4 | 56 | 2.14 |

The as-built hardness of Alloys A1, A2, and A4 are higher than other alloys (316L, M300, and 17-4PH) when they are printed on either a substrate, or previous solidified layer, having a temperature of 200° C. Alloy A1 and A4 have the same hardness as as-built H13, which was printed at 500° C. Additionally, Alloys A1, A2, A3, and A4 have lower abrasion wear mass loss, indicating better wear resistance, than 316L and M300. Abrasion wear mass loss of Alloys A1 and A3 were similar to that of H13, indicating similar wear resistance.

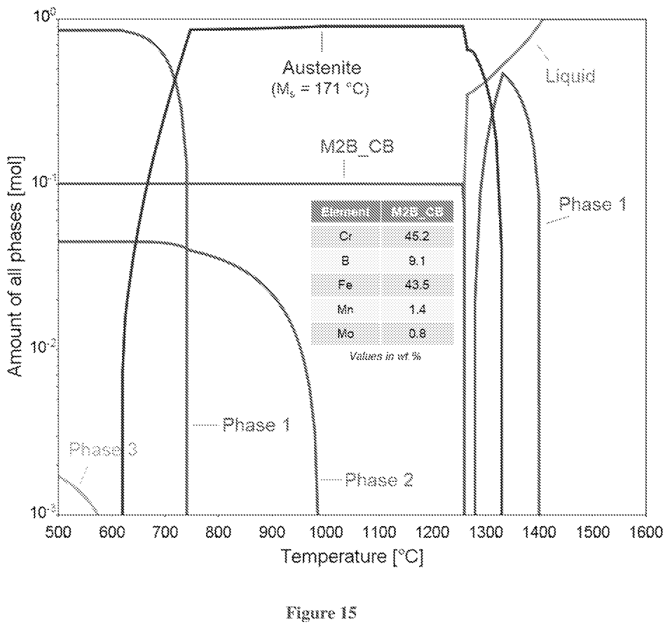

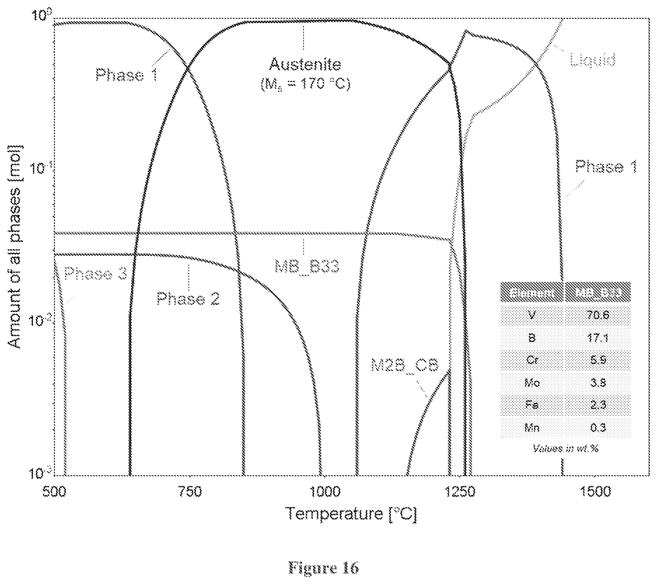

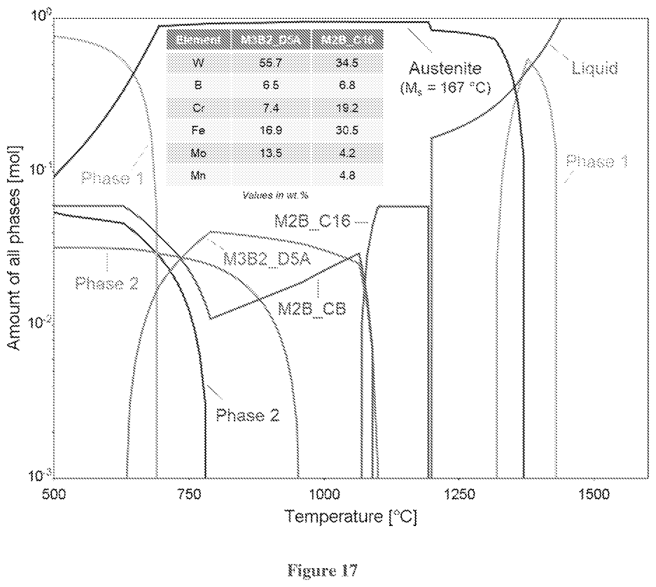

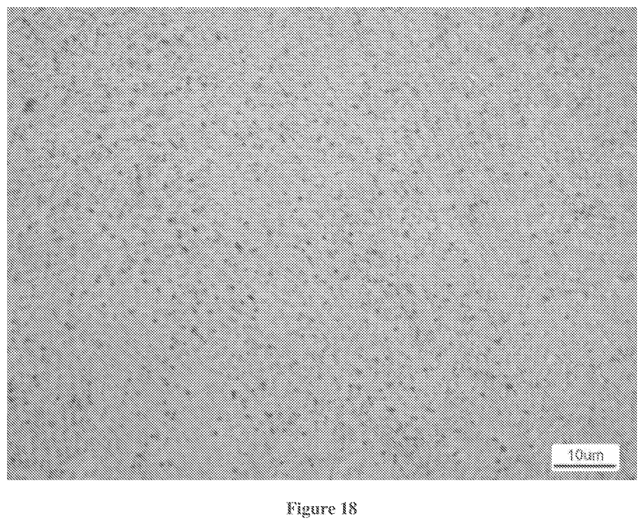

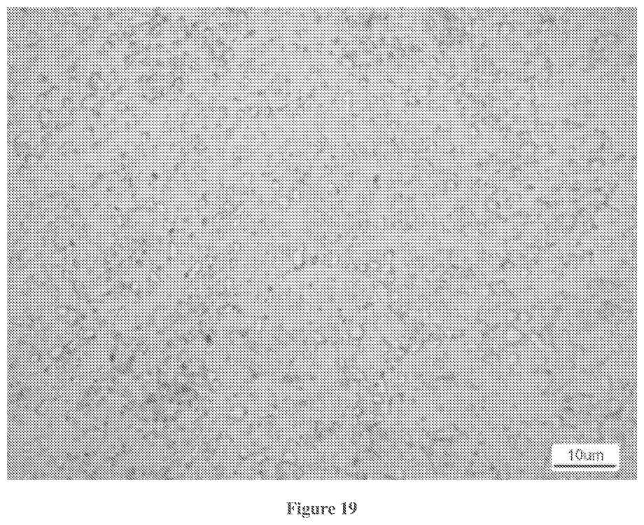

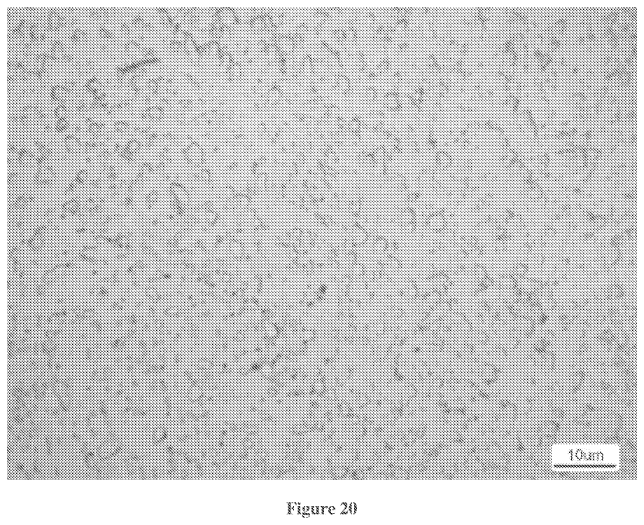

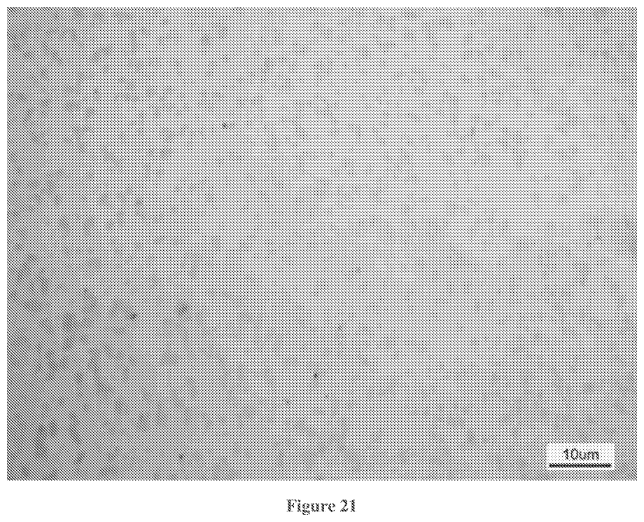

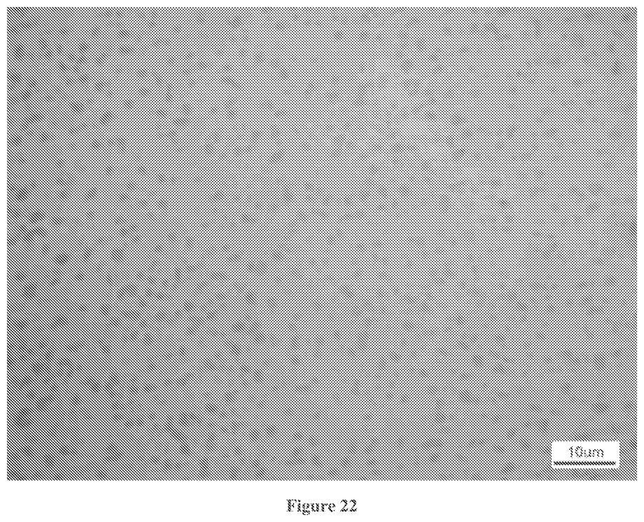

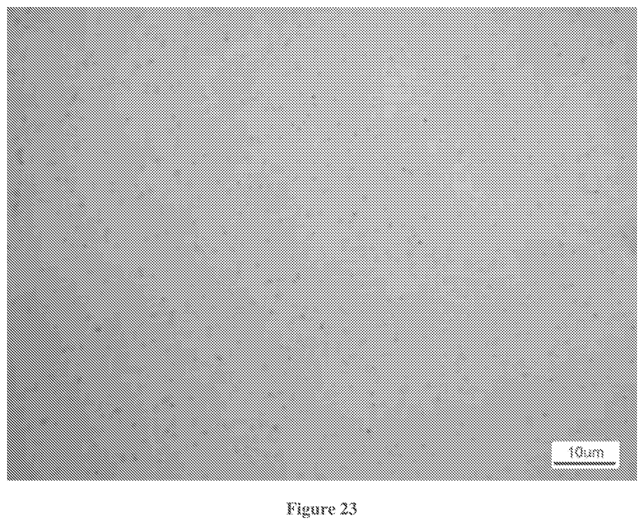

Wear resistance in tool steels is often a function of precipitate size and distribution. The equilibrium phase diagrams generated by Thermo-Calc software for Alloys A1, A3 and A4, which are shown in FIG. 15, FIG. 16, and FIG. 17 respectively, suggest that at temperatures at or above 1000° C., austenite with Mₛ above room temperature is formed and all precipitates other than borides dissolve, providing an opportunity to grow the boride phase in a commercially relevant temperature/time scale. As noted above, temperatures in the range of 900° C. to 1200° C. for 0,5 to 8.0 hours. The austenite has a calculated Mₛ of 165° C. to 175° C. and therefore is expected to transform to martensite by quenching the alloy after aging at these temperatures, preserving the hard martensitic matrix. FIG. 18, FIG. 19, and FIG. 20 show the microstructures of Alloy A1 after aging at 1100° C. for 2 hours, 4 hours, and 8 hours, respectively followed by a gas quench, freeze at −85° C. for 2 hours, and temper at 175° C. for 2 hours. This process is akin to a quench and temper typically used for martensitic tool steels. The dendritic microstructure observed in the as-built state in FIG. 8 is no longer present, replaced by a homogenous structure consisting of nominally round borides in a martensitic matrix. The diameter of the borides increases with aging time ranging from 0.1 microns to 1 micron after 2 hours and 1 micron to 4 microns after 8 hours. It is contemplated that the size of these borides can also be controlled by the temperature of the aging step. Similar microstructural evolution is observed in Alloy A3 in FIGS. 21 and 22, respectively, after the same heat treatment as Alloy A1 with an aging time of 2 hours and 8 hours respectively. FIG. 23 shows the microstructural evolution in Alloy A4 after the same heat treatment as Alloy A1 with an aging time of 8 hours, respectively.

Table 5 shows the tensile properties, hardness, and abrasion wear mass loss of Alloys A1, A2, A3, and A4 after heat treatment. Tensile properties, hardness, and abrasion wear mass loss were measured using the same methods used to record as-built values in Table 4. All tensile properties and hardness for Alloys A1, A2, A3, and A4 were recorded on pieces aged at 1100° C. for 8 hours followed by a gas quench, freeze at −85° C. for 2 hours, and temper at 175° C. for 2 hours. Abrasion wear mass loss for Alloys A1, A2, A3, and A4 were recorded on pieces aged at 1100° C. for 2 hours followed by a gas quench, freeze at −85° C. for 2 hours, and temper at 175° C. for 2 hours. For comparison, values of printed and heat treated M300, 17-4 PH, and H13 are also provided. The heat treatments done for these alloys were selected to maximize hardness. M300 was aged at 490° C. for 6 hours after printing. 17-4 PH was heat treated in accordance with ASTM A564M H900 procedure after printing. H13 was heated at 1050° C. for 0.5 hours, quenched, and tempered at 500° C. for 2 hours. As noted above, and as confirmed by Table 5, for a given printed part having an initial set of properties in the as-built condition, namely yield strength Y1, tensile strength TS1, elongation E1, HRC hardness H1 and abrasion wear resistance W1 (mass loss in grams via ASTM G65-16e1 Procedure A), after heat treatment, the properties indicate a second value for yield strength (YS2), tensile strength (TS2), elongation (E2), HRC hardness (H2) and abrasion wear resistance (W2). As can be seen from Table 5, the heat treated part can be characterized by any one or more of these secondary values that are observed as follows: YS2>YS1, TS2>TS1, E2≥E1, H2=H1+/−10 and W2<W1. More preferably, E2 is at least 5.0% greater than E1 and W2 is at least 0.5 lower in value than W1.

More specifically, for Alloys A1, A2, A3, and A4, the heat treatment increases the yield strength, tensile strength, and elongation while decreasing the abrasion wear mass loss (i.e. increasing wear resistance) from the as-built state. In particular, after heat treatment, the alloys herein indicate an elongation of at least 5.0%, a HRC hardness of at least 50 and abrasion wear resistance (mass loss in grams via ASTM G65-16e1 Procedure A) of less than or equal to 1.90. The abrasion wear mass loss of Alloys A1, A2, and A3 is lower than that for all conventional steels. The hardness after heat treatment increases from the as-built state for Alloy A3 but decreases for Alloys A1, A2, and A4. Nevertheless, the hardness of all new alloys remains at or above 50 HRC. Because the precipitate size and distribution can be controlled by aging time and/or temperature, as shown for Alloy A1 in FIGS. 18, 19 and 20, it is contemplated that the wear resistance can be tailored for a specific application.

TABLE 5

| | Yield | Tensile | | | Abrasion |
|---|---|---|---|---|---|
| | Strength | Strength | Elonga- | Hardness | Wear Mass |
| Alloy | (MPa) | (MPa) | tion (%) | (HRC) | Loss (g) |
| 316L | N/A | | | | |
| M300 | 2101 | 2196 | 4.2 | 54 | 2.92 |
| 17-4 PH | 770 | 965 | 13.8 | 41 | 2.75 |
| H13 | 1481 | 1481 | <0.1 | 58 | 1.48 |
| A1 | | | | 50 | 0.79 |
| A2 | 1206 | 1630 | 7.8 | 51 | 1.29 |
| A3 | 1275 | 1602 | 10.4 | 50 | 0.80 |
| A4 | 1267 | 1713 | 5.5 | 51 | 1.90 |

The foregoing description of several methods and embodiments has been presented for purposes of illustration. It is not intended to be exhaustive of to limit the claims to the precise steps and/or forms disclosed.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A method of layer-by-layer construction of a metallic part comprising:
supplying particles of an iron-based alloy, the iron-based alloy comprising:
Cr in an amount from 9.0 wt. % to 16.0 wt. %;
Ni in an amount from 0 to 5.0 wt. %;
Mo in an amount from 0 to 3.0 wt. %;
Mn in an amount from 0 to 3.0 wt. %;
C in an amount from 0.1 wt. % to 0.30 wt. %;
B in an amount 1.0 wt. or less %;
one or more elements selected from Cu, W, or V wherein:
when Cu is present it is present in an amount up to 2.5 wt. %;
when W is present it is present in an amount up to 7.5 wt. %;
when V is present it is present in an amount up to 3.5 wt. %;
the balance of the iron-based alloy containing Fe; and
forming an as-built metallic part at least in part by powder bed fusion comprising melting the particles into a molten state and cooling and forming one or more solidified layers of the iron-based alloy containing a martensitic matrix and one or more of a Cr-boride, W-boride when W is present or V-boride when V is present, wherein in the as-built part has a HRC hardness H1 and an abrasion wear resistance W1 (mass loss in grams via ASTM G65-16e1 Procedure A); and
heat treating the part, wherein the heat-treated part indicates a second value for HRC hardness (H2) and abrasion wear resistance (W2) where W2<W1.

2. The method of claim 1, wherein the as-built part has a tensile strength of at least 1000 MPa, a yield strength of at least 700 MPa, an elongation of at least 0.25%, and a hardness (HRC) of at least 40.

3. The method of claim 1, wherein after heat treatment, the metallic part has an elongation of at least 5.0%, a HRC hardness of at least 50 and abrasion wear resistance (mass loss in grams via ASTM G65-16e1 Procedure A) of less than or equal to 1.90.

4. The method of claim 1, wherein the heat treatment comprises heating at a temperature of 900° C. to 1200° C. for 0.5 to 8.0 hours.

5. (canceled)

6. The method of claim 1, wherein the alloy after heat treating contains at least one of a Cr-rich boride phase, a W-rich boride phase if W is present, or a V-rich boride phase if V is present.

7. The method of claim 1, wherein the alloy after heat treating contains a W-rich boride phase if W is present, or a V-rich boride phase if V is present;
wherein the alloy contains:
if W is present W in an amount of 0.1 wt. % to 5.5 wt. %;
if V is present, V in an amount of 0.1 wt. % to 2.25 wt. %.

8-10. (canceled)

11. A 3D printed metallic part comprising:
one or more layers an iron-based alloy, the iron-based alloy comprising:
Cr present in an amount from 9.0 wt. % to 19.0 wt. % based on the total weight of the alloy;
Ni present in an amount from 0 to 5.0 wt. % based on the total weight of the alloy;
Mo present in an amount from 0 to 3.0 wt. % based on the total weight of the alloy;
Mn present in an amount from 0 to 3.0 wt. % based on the total weight of the alloy;
C present in an amount from 0.1 wt. % to 0.30 wt. % based on the total weight of the alloy;
B present in an amount from 0 to 1.0 wt. % based on the total weight of the alloy;
one or more elements selected from Cu, W, or V wherein:
when Cu is present it is present in an amount up to 2.5 wt. % based on the total weight of the alloy;
when W is present it is present in an amount up to 7.5 wt. % based on the total weight of the alloy;
when V is present it is present in an amount up to 3.5 wt. % based on the total weight of the alloy.
the balance of the iron-based alloy containing Fe; and
wherein an as-built metallic part having one or more solidified layers of the iron-based alloy is formed having a martensitic matrix and one or more of a Cr-boride, W-boride when W is present or V-boride when V is present, wherein in the metallic part has a HRC hardness H1 and an abrasion wear resistance W1 (mass loss in grams via ASTM G65-16e1 Procedure A); and
wherein heat treating the as-built metallic part forms a heat-treated metallic part having a second value for HRC hardness (H2) and abrasion wear resistance (W2) where:
H2=H1+/−10; and
W2<W1.

12. The 3D printed part of claim 11, wherein the as-built metallic part has a tensile strength of at least 1000 MPa, a yield strength of at least 700 MPa, an elongation of at least 0.25%, and a hardness H1 of at least 40.

13. The 3D printed part of claim 11, wherein after heat treatment, the heat-treated metallic part has an elongation of at least 5.0%, a HRC hardness H2 of at least 50 and abrasion wear resistance W2 (mass loss in grams via ASTM G65-16e1 Procedure A) of less than or equal to 1.90.

14. The 3D printed part of claim 11, wherein Cu when present is present at a level of 0.15 wt. % to 0.30 wt. %, when W is present it is present at a level of 0.1 wt. % to 5.5 wt. % and when V is present it is present at a level of 0.1 wt. % to 2.25 wt. %.

15. The 3D printed part of claim 11, wherein the heat-treated metallic part contains at least one of a Cr-rich boride phase, a W-rich boride phase or a V-rich boride phase.

16. The 3D printed part of claim 11, wherein the heat-treated metallic part contains at least one a W-rich boride phase if W is present or a V-rich boride phase if V is present.

17. The 3D printed part of claim 11, wherein the alloy contains:
if W is present, W in an amount of 0.1 wt. % to 5.5 wt. %, and the heat-treated metallic part contains a W-rich boride phase; and
if V is present, V in an amount of 0.1 wt. % to 2.25 wt. %, and the heat-treated metallic part contains a V-rich boride phase.

18. The 3D printed part of claim 11, wherein the alloy comprises:
Cr in an amount from 9.0 wt. % to 19.0 wt. %;
Ni in an amount up to 3.0 wt. %;
Mo in an amount from 0.2 wt. % to 0.8 wt. %;
Mn in an amount from 0.75 wt. % to 3.0 wt. %;
C in an amount from 0.1 wt. % to 0.25 wt. %; and
B in an amount from 0.25 wt. % to 0.75 wt. %,
when Cu is present it is present in an amount up to 0.8 wt. %;
when W is present it is present in an amount up to 5.5 wt. %; and
when V is present it is present in an amount up to 2.5 wt. %.

19. An alloy for 3D printing with layer-by-layer construction of a metallic part, the alloy comprising:
Cr present in an amount from 9.0 wt. % to 19.0 wt. % based on the total weight of the alloy;
Ni present in an amount from 0 to 5.0 wt. % based on the total weight of the alloy;
Mo present in an amount from 0 to 3.0 wt. % based on the total weight of the alloy;
Mn present in an amount from 0 to 3.0 wt. % based on the total weight of the alloy;
C present in an amount from 0.1 wt. % to 0.30 wt. % based on the total weight of the alloy;
B present in an amount from 0 to 1.0 wt. % based on the total weight of the alloy; and
one or more elements selected from Cu, W, or V wherein:
when Cu is present it is present in an amount up to 2.5 wt. % based on the total weight of the alloy;
when W is present it is present in an amount up to 7.5 wt. % based on the total weight of the alloy; and
when V is present it is present in an amount up to 3.5 wt. % based on the total weight of the alloy.

20. The alloy of claim 19, wherein the alloy, when printed, is capable of forming an as-built metallic having a martensitic matrix and one or more of a Cr-boride, W-boride when W is present or V-boride when V is present, wherein the as-built metallic part has a HRC hardness H1 and an abrasion wear resistance W1 (mass loss in grams via ASTM G65-16e1 Procedure A); and
wherein heat treating the as-built metallic part forms a heat-treated metallic part having a second value for HRC hardness (H2) and abrasion wear resistance (W2) where:
H2=H1+/−10; and
W2<W1.

21. The alloy of claim 19, wherein the alloy, when printed, is capable of forming an as-built metallic part having a tensile strength of at least 1000 MPa, a yield strength of at least 700 MPa, an elongation of at least 0.25%, and a hardness H1 of at least 40.

22. The alloy of claim 19, wherein after heat treatment, the heat-treated metallic part has an elongation of at least 5.0%, a HRC hardness H2 of at least 50 and abrasion wear resistance W2 (mass loss in grams via ASTM G65-16e1 Procedure A) of less than or equal to 1.90.

23. The alloy of claim 19, wherein the alloy comprises:
Cr in an amount from 9.0 wt. % to 19.0 wt. %;
Ni in an amount up to 3.0 wt. %;
Mo in an amount from 0.2 wt. % to 0.8 wt. %;
Mn in an amount from 0.75 wt. % to 3.0 wt. %;
C in an amount from 0.1 wt. % to 0.25 wt. %; and
B in an amount from 0.25 wt. % to 0.75 wt. %.

24. The alloy of claim 19, wherein the alloy comprises:
if W is present, Win an amount of 0.1 wt. % to 5.5 wt. %, and a heat-treated metallic part contains a W-rich boride phase; and
if V is present, V in an amount of 0.1 wt. % to 2.25 wt. %, and a heat-treated metallic part contains a V-rich boride phase.
